(19) United States
(12) Patent Application Publication
(10) Pub. No.: US 2002/0077890 A1
(43) Pub. Date: Jun. 20, 2002

(54) Methods and systems for interactive collection, exchange and redemption of points

(76) Inventors: Patrick L. LaPointe, Princeton Junction, NJ (US); Bradley G. Forsythe, Cincinnati, OH (US)

Correspondence Address: DINSMORE & SHOHL, LLP, 1900 CHEMED CENTER, 255 EAST FIFTH STREET, CINCINNATI, OH, 45202, US

(21) Appl. No.: 09/737,105

(22) Filed: Dec. 14, 2000

(51) Int. Cl. G06F 17/60

(52) U.S. Cl. 705/14; 705/37

(57) ABSTRACT

Method for interactive collection, exchange and redemption of reward points relating to products or services including the step of identifying a user; retrieving a point balance corresponding to the user; offering a list of reward options to the user; receiving a selection option from the user corresponding to the list of reward options; prompting the user to input a bid value for the selected reward option; prompting the user to input a bid value for the selected reward option; receiving the bid value from the user corresponding to the selection option; deducting a bid fee from the point balance of the user; determining if the user's bid value is a winning bid value at a pre-determined time; and awarding the selection option to the user and deducting the bid value from the point balance, if the user's bid is the winning value. Interactive system for collection, exchange and redemption of reward points relating to products or services, having: a user interface; a point manager in communication with a personal data store and the user interface, wherein the point manager includes executable instructions for determining a user's point balance from the personal data store; and a redemption module in communication with the point manager, wherein the redemption module includes executable instructions for offering items for redemption to a user and determining a winning bid from a user.

### FIELD OF THE INVENTION

The present invention relates generally to providing incentives for consumers interactions with companies and more specifically to methods and systems for using incentive points awarded by companies to consumers for redemption of various awards.

### BACKGROUND OF THE INVENTION

Reward points provided by companies to consumers are commonplace in today's society. Consumers are typically awarded points for using their credit cards, purchasing a specific product, and using a particular service. Consumers typically have reward-point balances with a variety of companies and when the balance of any one of these individual accounts reach an award-level amount with the company providing the points, the consumer is either provided a product or service or the consumer is given the opportunity to purchase or redeem the points for a desired product or service.

Moreover, a variety of Internet-based organizations provide a form of reward points to consumers if the consumers perform certain tasks such as taking online surveys, visiting specific World Wide Web (WWW) sites, or signing up for a variety of services (e.g., Internet Service Providers (ISP)). However, each of the variety of organizations which award consumers points for redemption maintain individual rules with respect to these points When a consumer initially subscribes in a particular organization's reward points service, the consumer typically agrees to a boiler-plate agreement which restricts and circumscribes how the consumer may use the points awarded. For example, points often expire, are not useable during certain calendar dates, are not useable for certain products and services, often have no cash redemption value, and are non transferable.

Typically, companies must include the value of outstanding points in their financial reporting obligations. Many consumers fail to redeem their points due to their balance being less than the level required for an award redemption. For example, a consumer may have 2,500 miles (points) in a frequent flyer account, but the first award level requires 10,000 miles. As a result, the consumer is unable to deplete their balance and the company is required to track the balance and account for the value of unredeemed points in their financial reports. Due to the large proliferation of these outstanding points and the decline in redemption of points for individual awards, the financial reporting requirements can unduly cloud an organization's financial picture. As a result, organizations with reward point programs have attempted to find creative ways in which the consumer will utilize and expend his/her point balance. Some of these creative techniques include inter-organization partnerships where two or more organizations honor the points of each other, permitting a consumer for example to use airline frequent flier miles for one airline where the frequent flier miles are from an entirely different airline. Another example includes using hotel frequent stay points for airline frequent flyer miles. More recently, various companies have formed partnering agreements with organizations to provide relatively inexpensive goods or services to the consumer in exchange of a low amount of points, in an attempt to have the consumer deplete their point balance which subsequently reduces the companies required and costly financial reporting of unused points. For example, the consumer may receive an offer to subscribe to a variety of magazines in exchange for all or part of the consumers remaining point balance. These offers are typically only sent to consumers with point balances below the redemption level for any award.

Yet, many of the programs initiated by organizations to eliminate outstanding point balances from their financial books have proven unsuccessful for a number of reasons, such as a consumer's natural aversion for telemarketers and “junk” mail. Historically, “junk” mail was received via the regular post office, however with recent advances in technology “junk” mail arrives through a variety of media channels such as electronic mail (e-mail), facsimile, electronic pages, automated voice systems, WWW advertisement banners, and the like.

Moreover, consumers are typically subscribed to multiple point-based programs and consequently they often become unaware of which programs they are registered for. In addition, due to varying requirements of each program, the consumer is often unaware or unsure how to redeem point balances and when the points may expire.

As such there remains a need for methods and systems for consumers to more freely redeem award points, thus reducing the financial reporting obligations for the companies.

### SUMMARY OF THE INVENTION

Accordingly, it is an object of the present invention to provide novel methods and systems for interactive collection, exchange and redemption of reward points which overcome one or more disadvantages of the prior art. These and additional objects and advantages are provided by the methods and systems for interactive collection, exchange and redemption of reward points of the present invention.

One aspect of the present invention is the method for the interactive collection, exchange and redemption of reward points. The method comprises offering a list of reward options to a user. The user's selected option corresponding to the list of reward options is received. The user is prompted to input a bid for the selected reward option. The user's bid is received. The user's bid is compared to a high bid. If the user's bid is not greater than the high bid, the user is prompted to enter a higher bid. A bid fee is then deducted from the user's point balance. At a predetermined time, the user with the highest bid will be awarded the selected reward option.

Another aspect of the present invention is the interactive system for interactive collection, exchange and redemption of reward points. The interactive system comprises a user interface, a personal data store, a point manager and a redemption module. The point manager is in communication with the personal data store and the user interface. The point manager comprises executable instructions for determining a user's point balance from the personal data store. The redemption module is in communication with the point manager. The redemption module comprises executable instructions for offering items for redemption to a user and determining a winning bid from a user.

Still other objects, advantages and novel features of the present invention will become apparent to those skilled in the art from the following detailed description which is simply, by way of illustration, various modes contemplated for carrying out the invention. As will be realized, the invention is capable of other different and obvious aspects, all without departing from the invention. Accordingly, the drawings and descriptions are illustrative in nature and not restrictive.

### BRIEF DESCRIPTION OF THE DRAWINGS

While the specification concludes with claims particularly pointing out and distinctly claiming the present invention, it is believed that the same will be understood from the following description taken in conjunction with the accompanying drawings in which:

FIG. 1 depicts a flow diagram of the interactive method of the present invention;

FIG. 2 depicts a schematic illustration of the interactive system of the present invention; and

FIG. 3 depicts a flow diagram of another embodiment of a method of the present invention.

### DETAILED DESCRIPTION

The present invention provides methods and a system which permit users, to redeem points through purchases and auctions for reward items (e.g., services, products, discounts, and the like). The points of the users are maintained in electronic accounts and may be transferred among multiple users enabling users to increase their individual point balances for purposes of acquiring more desirable and costly reward items, such as exotic vacations.

One embodiment of the present invention, depicted in FIG. 1 +L, comprises a method for interactive collection, exchange and redemption of reward points relating to products or services. First, a user is identified (20). In one embodiment, the user is prompted to enter a username and password. Other embodiments include use of cookies, biometric identifiers and other authentication processes known to those skilled in the art. A point balance corresponding to the user is then retrieved from a personal data store (22). A list of reward options is then presented to the user (24). Exemplary reward options may include merchandise (i.e., computers, software, PDA's, wireless phones, etc.) and experiences (i.e., travel, celebrity interactions, exclusive privileges, etc.). Potential reward options include a reward auction, in which the user can bid on a reward item with his/her reward points. The user's selection corresponding to the list of reward options is received (26). The user is then prompted to enter a bid value (28) corresponding to the selected reward option. The bid value is received from the user (30). In one embodiment, a check is performed to ensure that the user has enough points to cover the bid. After receiving the bid value, the bid value is compared against a high bid value to determine if the user's bid is greater than the high bid (31). If the user's bid value is not greater than the high bid value, the user is prompted to enter a high bid value (55). After the user's bid is received and determined to be greater than the high bid, a bid fee is deducted from the user's point balance (32). The bid fee ranges from about 0.01 percent to about 20 percent of the bid value. More preferably, the bid fee ranges from about 0.1 percent to about 10 percent of the bid value; most preferably, the bid fee ranges from about 1 percent to about 5 percent of the bid value. In another embodiment, the bid fee is a pre-determined number of points. At the pre-determined end of the auction, the user's bid is compared against any other bids to determine if the user has the winning bid (34). If the user has the winning bid, the bid value is deducted from the user's point balance (38) and the selected reward option is provided to the user (40). If the user did not win the auction, the user is returned to the list of selection options. In one embodiment, the user is notified whenever another bid is greater than his/her bid. As one skilled in the art will appreciate, the method of the present invention can be utilized with a wide variety of auctions such as reverse, Dutch, English and the like.

Preferably, the method comprises the ability to transfer point balances from various accounts. These accounts may belong to the same user or different users. For example, Joe may have frequent flyer accounts with four airlines with an aggregate balance of 175,000 miles. Joe may be interested in bidding on a guest appearance on a TV show such as Baywatch, which currently has a high bid of 120,000 miles, however Joe does not have a single account with 120,000 miles. Under the present invention, a user can transfer balances from other accounts in order to have enough points. The method comprises identifying the user and retrieving all accounts registered to the user. The user is then prompted to input a transfer amount and which accounts should be utilized for the transfer. Preferably, the user inputs the amount to be transferred from each account. In another embodiment, the present invention will determine what amounts to remove from each account. The transfer point value is then transferred from the various accounts into the selected account. A transfer fee is then deducted from the selected account. The transfer fee ranges from about 0.01 percent to about 20 percent of the transfer value. More preferably, the transfer fee rangers from about 0.1 percent to about 10 percent of the transfer value; even more preferably from about 1 percent to about 5 percent of the transfer value; and most preferably from about 1 percent to about 3 percent of the transfer value.

In another embodiment, points can be transferred between two or more users. Preferably, a user messaging/chat module is provided. The messaging/chat module comprises executable instructions for allowing users to engage in conversation and post messages both publicly and privately regarding potential bartering or exchanges of reward points. Once the user has reached an agreement to receive points transferred from another user, the user enters the required transfer information. For example, each user must enter the identical alphanumeric password for the transaction. Preferably, a confirmation is sent to the other user to authorize the transfer. Once the other user authorizes the transfer, points are transferred between the two users and a transfer fee is deducted from the user's point balance. This transfer can comprise free goodwill or some bartered, agreed upon exchange. To facilitate, the bartering and exchange process, one embodiment of the present invention further comprises a messaging and chat system. This system allows the exchange of ideas and leading up to the eventual exchange of points. For example, a first and second user may communicate via a private chat room contained on the service web pages or via email, and once an agreement is reached points are transferred between the users. For example, Steve wants to bid on a round of golf with a top golf professional which has a current bid of 80,000 points. Currently, Steve only has 60,000 points between his accounts. Steve could choose to enter the messaging/chat area of the system and engage various users in potential bartering and transfer discussions. Upon reaching a transfer agreement with Jesse, Steve enters the required transfer information into the system. Preferably a confirmation is sent to Jesse to authorize the transfer. Steve then can bid on the reward for the round of golf with a top golf professional.

Similarly, in another embodiment two or more users can combine their points towards an award redemption. Preferably, a user messaging/chat module is provided. The messaging/chat module comprises executable instructions for allowing users to engage in conversation and post messages both publicly and privately regarding potential bartering or combination of reward points. Once the users has reached an agreement to combine their points, the users enter the required information for combining their points. For example, each user would enter the identical alphanumeric password for that specific transaction. Preferably, a confirmation is sent to the other user to authorize the point combination. Once the other user authorizes the combination, points are combined between the two users. The remaining steps are similar to the embodiments with only one user. This embodiment allows multiple users to “pool” their points into one large bid to be able to redeem an award that they otherwise would not be able to redeem due to lack of points.

In one embodiment, a corporate enterprise “sponsors” users, wherein the corporate enterprise may pay the transaction fees associated with the user's transactions (bidding and/or transferring points). In one exemplary embodiment, only user's who entered the sponsoring corporate enterprise's identifier would be “sponsored” by the corporate enterprise, wherein all other user's who did not enter the corporate enterprise identifier would be required to pay their own fees out of their point balance.

In yet another embodiment, a sponsoring organization may enroll their members in the system and utilize the system for administrative management of their members point balances. For example, Sears becomes a coalition sponsor by enrolling members in the system. Sears can utilize the administrative features of the system as a communications channel to communicate directly to “Sears Only” enrolled members. Accordingly, Sears could send special earning or spending offers or other Sears related product/service information to the “Sears Only” members.

Another embodiment of the present invention, depicted in FIG. 2 +L, is a system for interactive collection, exchange and redemption of reward points. The system (100) comprises a user interface (105), a point manager (110), a personal data store (130) and a redemption module (120). The point manager (110) is in communication with the personal data store (130) and the user interface (105). The point manager (110) comprises executable instructions for determining a user's point balance from the personal data store (130). The redemption module (120) is in communication with the point manager (110). The redemption module (120) comprises executable instructions for offering items for redemption to a user and determining a winning bid from a user. In a preferred embodiment, the system (100) further comprises a reward data store (140) which is in communication with the redemption module (140). The reward data store (140) contains data pertaining to available rewards of the present invention.

As one skilled in the art will appreciate these executable instructions need not reside on a single processor, but may reside remotely on a variety of processors and may communicate with each other via standard software. In this way, the implementation of the executable instructions is more of a client-server or distributed-based architecture creating greater flexibility for the users and support personnel using the set of executable instructions.

The point manager (110) is preferably provided in communication, such as via a token ring, Ethernet, telephone modem connection, radio or microwave connection, parallel cables, serial cables, telephone lines, universal serial bus “USB”, Firewire, Bluetooth, fiber optics, infrared “IR”, radio frequency “RF” and the like, or combinations thereof with the personal data store (130) and the user interface (105).

In a consumer products application, the user interface (105) might preferably comprise a kiosk, a computer, a personal digital assistant (PDA), a device with wireless application programs (WAP) such as cell phone, auto computer or PDA, interactive TV, or an Internet appliance, or the like. User interface (105) allows the user to communicate and interact with the interactive system (100) and, as will be understood, can take any of a virtually unlimited number of alternative forms. In a preferred embodiment, the user interface (105) may comprise a computer system comprising a CPU, memory, a visual display device and an input means. Preferred input means comprise a keyboard or mouse or other means of input such as speech recognition and/or visual input utilizing a video camera In a preferred embodiment, the user interface (105) comprises a computer connected to the Internet through a communication link and running a web browser such as Internet Explorer from Microsoft Corp. or Netscape Navigator from Netscape Communications Corp.

Yet another embodiment of the present invention comprises a method for the interactive collection, exchange and redemption of reward points relating to products or services. The method is depicted in the flowchart of FIG. 3 +L. First, the user is identified (300). The identification process can be any of those known to one skilled in the art such as usernames, passwords, cookies, biometrics, two-factor identification, and the like. Then the method determines whether the user has an account in a data store (310). If the user does not have an account in the data store, an account is created in the data store corresponding to the user (320). The user's point balance is then retrieved from the data store (330). The user is then provided a list of interactive options (340). In one embodiment, the list of interaction options corresponds in at least part to the point balance of the user. Preferred interactive options include reward auction, reward purchase and point balance transfers. Additional interactive options may include reward conversions, which involves exchanging one “currency” (one program's points) for another at a defined exchange rate; checking point balances; viewing ‘rules’ for auction/transfer/redemptions; browse various rewards (opportunity to create aspiration); view advertisements from various sponsors; browse special offers made to members by various sponsors; browse the proprietary loyalty programs of various sponsor; join various corporate sponsor programs; and link to various websites. The interactive option selected by the user is then received (350). The method then provides the user a list of selection options corresponding to the interactive selection (360). For example, if the user selected reward auction, the user may then be provided with a list of items currently available for auction. The user's selected option is then received (370). The item corresponding to the selected option is then provided to the user (380) and a transaction value is deducted from the user's point balance (390). In one embodiment, the selected option may comprise a bid on an item in a reward auction, in which the bid is registered to the consumer and the transaction value comprises a bid fee. If the user wins the auction, the transaction value will further comprise the bid value of the item.

One embodiment of the present invention is implemented using web browser technologies including well-known software programming languages (e.g., C, C++, Java, Active X, Active Server Pages) and Internet communication protocols (TCP/IP). Of course other programming languages and communications protocols (now known or hereafter developed) may be also readily employed.

Typically, a user would connect to the system of the present invention by using a web browser and accessing the system by using universal resource locator (URL) to retrieve the web pages of the system. Once at the system, web pages are coded in a variety of standard data tagging formats which standard web browsers recognize such as, hypertext markup language (HTML), portable document format (PDF), extended markup language (XML), extended style sheet language (XSL), or a variety of other non-standard formats such as Word, Word Perfect, et al. These web pages create a predefined pre-structured interface within which the users access various services and accounts. Moreover, these pages are displayed in a user-friendly manner permitting the user to execute software programs by activating selected areas of the page. For example, a web page asking for a user's login identification tag and password may be encoded in HTML so that the areas on the page where information is entered by the user is stored in standard programming variables, and once a user strikes a return key or depresses a login button, a software program is executed using the variables containing the user's information. A query to a relational database then determines if the user is a valid subscriber to the service and if so, a web page is constructed using a template where information regarding the user is filled in, and a new customized web page is displayed to the user.

Points can be provided to the users in a variety of ways. For example, points may be purchased for money by the user, may be acquired by trying a good or a service, may be acquired by visiting web sites, taking surveys, and the like. Organizations desiring to relieve themselves of managing and administering point-based programs may permit their points to be converted to points of the service and used within the service. Further, organizations may purchase large blocks of points and make them freely available to their customers, in this way the service acquires significant revenues.

The foregoing description and specific embodiments set forth herein have been presented for purposes of illustration and description It is not intended to be exhaustive nor to limit the invention to the precise form disclosed. Many alternatives, modifications, and variations will be apparent to those skilled in the art in light of the above teaching. Accordingly, this invention is intended to embrace all alternatives, modifications, and variations that fall within the spirit and broad scope of the attached claims.

What is claimed is:

1. A method for interactive collection, exchange and redemption of reward points relating to products or services, comprising the steps of:
a) identifying a user;
b) retrieving a point balance corresponding to the user;
c) offering a list of reward options to the user;
d) receiving a selection option from the user corresponding to the list of reward options;
e) prompting the user to input a bid value for the selected reward option;
f) receiving the bid value from the user corresponding to the selected reward option;
g) determining if the bid value is a high bid;
h) prompting the user to input a higher bid value for the selected reward and repeat steps f-h, if the bid value is not the high bid;
i) deducting a bid fee from the point balance of the user;
j) determining if the user's bid value is a winning bid value at a pre-determined time; and
k) awarding the selection option to the user and deducting the bid value from the point balance, if the user's bid value is the winning bid value.

2. The method of claim 1, further comprising:
identifying a second user;
retrieving a second point balance corresponding to the second user;
prompting the user to input a transfer value;
receiving the transfer value from the user
transferring the transfer value from the second point balance to the point balance corresponding to the user; and
deducting a transfer fee from the point balance corresponding to the user.

3. The method of claim 1, wherein the step of identifying a user comprises retrieving a username and password from the user.

4. The method of claim 1, further comprising the steps of:
determining a user's reward stage in at least part from the point balance of the user.

5. The method of claim 4, wherein the list of reward options correspond to the user's reward stage.

6. The method of claim 2, further comprising the step of confirming with the second user the point balance transfer.

7. The method of claim 1, wherein the bid fee ranges from about 0.01 percent of the bid value to about 20 percent of the bid value.

8. The method of claim 1, wherein the bid fee ranges from about 1 percent of the bid value to about 5 percent of the bid value.

9. The method of claim 2, wherein the transfer fee ranges from about 0.01 percent of the transfer value to about 20 percent of the transfer value.

10. The method of claim 2, wherein the transfer fee ranges from about 1 percent of the transfer value to about 3 percent of the transfer value.

11. An interactive system for interactive collection, exchange and redemption of reward points, comprising:
a user interface;
a point manager in communication with a personal data store and the user interface, wherein the point manager comprises executable instructions for determining a user's point balance from the personal data store; and
a redemption module in communication with the point manager, wherein the redemption module comprises executable instructions for offering items for redemption to a user and determining a winning bid from a user.

12. The system of claim 11, wherein the point manager further comprises executable instructions to deduct bid fees from a user's point balance.

13. The system of claim 11, further comprising a messaging module, wherein the messaging module comprises executable instructions for providing message postings and chat room services to users of the system.

14. A computer-readable medium containing instructions for controlling a computer system to interact with a user for interactive collection, exchange and redemption of reward points relating to products or services, comprising the steps of:
a) identifying a user;
b) retrieving a point balance corresponding to the user;
c) offering a list of reward options to the user;
d) receiving a selection option from the user corresponding to the list of reward options;
e) prompting the user to input a bid value for the selected reward option;
f) receiving the bid value from the user corresponding to the selected reward option;
g) determining if the bid value is a high bid;
h) prompting the user to input a higher bid value for the selected reward and repeat steps f-h, if the bid value is not the high bid;
i) deducting a bid fee from the point balance of the user;
j) determining if the user's bid value is a winning bid value at a pre-determined time; and
k) awarding the selection option to the user and deducting the bid value from the point balance, if the user's bid value is the winning bid value.

15. A network-based method for interactive collection, exchange and redemption of information relating to products or services, comprising the steps of”
providing a web site having a user interface;
receiving at the user interface one or more items of user input from a user;
identifying the user from the items of user input;
retrieving the user's point balance from a personal data store;
offering to the user a list of reward options;
receiving a selection option from the user corresponding to the list of reward options;
prompting the user to input a bid value for the selected reward option;
receiving the bid value from the user corresponding to the selection option;
deducting a bid fee from the point balance of the user;
determining if the user's bid value is a winning bid value at a pre-determined time; and
awarding the selection option to the user and deducting the bid value from the point balance, if the user's bid value is the winning bid value.

16. A computer data signal embedded in a carrier wave for transmitting executable instructions for the interactive collection, exchange and distribution of reward points relating to products or services, the signal comprising the instructions:
identifying a user;
retrieving a point balance from a personal data store;
offering to the user a list of reward options;
receiving a selection option from the user corresponding to the list of reward options;
prompting the user to input a bid value for the selected reward option;
receiving the bid value from the user corresponding to the selection option;
deducting a bid fee from the point balance of the user;
determining if the user's bid value is a winning bid value at a pre-determined time; and
awarding the selection option to the user and deducting the bid value from the point balance, if the user's bid value is the winning bid value.

17. A method for interactive collection, exchange and redemption of reward points, comprising the steps of:
identifying a user;
determining if the user has an account in a data store;
if the user does not have an account in the data store, creating an account in the data store corresponding to the user;
retrieving a point balance corresponding to the user's account in the data store;
providing the user a list of interactive options;
receiving from the user an interactive selection;
providing the user a list of selection options corresponding to the interactive option;
receiving from the user an option selection;
providing the user an item corresponding to the selected option; and
deducting a transaction fee from the user's point balance.

18. The method of claim 17, wherein the list of interactive options comprises reward auction, reward redemption and point balance transfers.

19. The method of claim 18, wherein when the interactive selection comprises reward auction, the method further comprises the step of deducting a bid fee from the user's point balance.

20. The method of claim 18, wherein when the interactive selection comprises point balance transfers, the method further comprises the step of deducting a transfer fee from the user's point balance.

21. The system of claim 11, wherein the redemption module further comprises an auction submodule, wherein the suction submodule comprises executable instructions for performing an auction between users utilizing the reward points.

22. The system of claim 21, wherein the redemption module further comprises a purchase module, wherein the purchase module comprises executable instructions for offering to the user various awards for purchase with at least a portion of the reward points.

23. The system of claim 11, wherein the point manager further comprises a point transfer module, wherein the point transfer module comprises executable instructions for transferring at least a portion of a user's point balance to another user's point balance.

24. The method of claim 1, wherein the step of deducting a bid fee comprises deducting a bid fee from a corporate enterprise account.

25. The method of claim 2, wherein the step of deducting a transfer fee comprises deducting a transfer fee from a corporate enterprise account.

26. The system of claim 11, wherein the point manager further comprises executable instructions to deduct bid fees from a corporate enterprise account.
